(19) United States
(12) Patent Application Publication
(10) Pub. No.: US 2004/0232041 A1
(43) Pub. Date: Nov. 25, 2004

(54) Method for making a low sulfur petroleum pitch

(75) Inventors: Melvin D. Kiser, Huntington, WV (US); Patricia K. Doolin, Ashland, KY (US); David C. Boyer, Huntington, WV (US)

Correspondence Address: EMCH, SCHAFFER, SCHAUB & PORCELLO CO, P O BOX 916, ONE SEAGATE SUITE 1980, TOLEDO, OH, 43697

(73) Assignee: Marathon Ashland Petroleum LLC, Findlay, OH

(21) Appl. No.: 10/443,649

(22) Filed: May 22, 2003

(51) Int. Cl. C08L 95/00; C10G 45/00; C10G 45/04

(52) U.S. Cl. 208/22; 208/14; 208/44; 208/216 R; 208/217

(57) ABSTRACT

Fractions derived from a high sulfur content crude oil, having a sulfur content of about 2 wt. % or greater, is hydrotreated to produce a petroleum pitch not only having a low sulfur content of about 1 wt % or less but also a low polycyclic aromatic hydrocarbon (PAH) content of about 13,000 mg/kg or less.

### FIELD OF INVENTION

This invention relates to a process for producing a low sulfur and low polycylic aromatic hydrocarbon feedstock. A supply of relatively high sulfur content crude oil with a sulfur content of about 1 wt. % or higher is subjected to deep desulfurization to produce a low sulfur, low PAH petroleum feedstock with a sulfur content of about 1 wt. % or lower. The process disclosed herein is unique in many respects. Of particular importance is that this process can operate using relatively impure or high sulfur content feedstock for the production of low sulfur, low PAH petroleum feedstock and produces a feedstock especially useful for the production of petroleum pitch. The invention also relates to a petroleum pitch having a low sulfur content. The petroleum pitch produced by the process of the present invention is especially useful for making anode grade pitch binder materials.

### BACKGROUND OF THE INVENTION

Pitch has been used for many years for a variety of applications. Pitch can be derived from various sources, with the most common sources being coal tar or petroleum (crude oil). In many applications, pitch is used as a carbon precurser material where the final artifact is heated to temperatures exceeding 2000° C. Under these conditions, sulfur present in the pitch can be released to the atmosphere, thus requiring emission abatement equipment. In certain applications such as graphitization, i.e., the formation of graphite objects, sulfur can be evolved at temperatures exceeding 1,600° C. Evolution of sulfur of this type can substantially weaken the structure of graphite objects. In addition, the presence of sulfur is believed to be a source of increased corrosion in certain applications such as aluminum anodes.

Petroleum pitch can be made from a multitude of different feedstocks using a variety of processes. R. H. Wombles, M. D. Kiser, “Developing Coal Tar/Petroleum Pitches,” Light Metals, 2000, The Minerals, Metals, and Materials Society, Warrendale, Pa. 2000. The feedstocks can range from a predominantly aliphatic to a predominantly aromatic type chemical structure.

Regardless of the source (coal tar or petroleum), the sulfur content of the pitch is normally a function of the sulfur content of the pitch feedstock. Coal tar pitch has historically been classified as low sulfur (<1.0 wt %) pitch. Recently, reductions in the amount of available coal tar pitch from domestic United States sources have been observed. These reductions are projected to continue as additional coal tar production facilities are closed due to increasing regulatory, i.e., environmental concerns. The quality of petroleum crude oil has also changes during the last few decades. Beginning in the 1970's, the availability of “sweet,” i.e., low sulfur crude oils became increasingly short in supply. Therefore, the petroleum industry is increasing forced to use “sour” crude oils that have high sulfur contents. The sulfur content of the resulting pitch products has consequently increased up to 3 wt. % and higher.

Catalytic hydrogenation has long been used to treat petroleum residues which are produced from the atmospheric and vacuum distillation of petroleum feedstock. The distillation of these petroleum feedstock tends to concentrate the contaminants in the petroleum residue. The hydrotreatment involved treating the petroleum residue with hydrogen in the presence of a catalyst to convert the petroleum residue into a higher proportionate more valuable end product. The residue remaining after the more valuable products are removed from the hydrotreater generally had a lower sulfur content.

A low sulfur petroleum pitch has been produced from a petroleum feedstock derived from a steam cracker used to produce ethylene. The bottoms from this process are referred to as ethylene cracker bottoms or ECBs. Like other types of petroleum feedstocks and pitch, the sulfur content will vary based on the sulfur content of the incoming feedstock. The feedstock for ethylene crackers are known to vary, ranging from naphtha (having a very low sulfur content) to heavy gas oils (having a sulfur content in the 2 to 3 wt % level). Other characteristics such as a very high viscosity of ECB type feedstocks for petroleum pitch feedstock present difficulties as well.

Therefore, there is a need to produce a petroleum feedstock having low sulfur such that the petroleum feedstock can be used to produce such intermediate products as low sulfur petroleum pitch which, in turn, is used to produce a high value end product such as anodes for aluminum manufacturing.

In addition to sulfur content, one other property of pitch (coal tar or petroleum) that is a concern in the industry is the concentration of regulated polycyclic aromatic hydrocarbons (PAH's). These compounds are suspected carcinogens and, as such, are regulated by the United States Environmental Protection Agency. These PAH's include, for example, benzo(a)anthracene, chrysene (benzo(a)phenanthrene, benzo(a)pyrene, benzo(g,h,i)perylene, fluoranthene (benzo(j,k)flourene), dibenz(a,h)anthracene, indeno(1,2,3-cd)pyrene, naphthalene, acenaphthalene, acenapthene, fluorine, phenanthrene, anthracene, pyrene, benzo(b)fluoranthene.

Although various improvements have been suggested over the years, there is still a distinct need in the art for an economical process for producing low sulfur feedstocks which are useful for producing valuable low sulfur, low PAH petroleum based pitch and end products produced therefrom.

One past method of generating very low sulfur petroleum pitch was hydrotreatment of a pitch product itself, such as the Marathon Ashland A-240 pitch. Pitch produced from this process was found to have sulfur contents between 0.25 and 0.30 wt %. Processing difficulties and cost prevented this method of production from being commercially viable.

A second type of pitch, A-225, is also available for different end use applications. This pitch product has a lower softening point pitch than A-240 pitch (110° C. versus 120° C.). The maximum sulfur content of this pitch is set at 1.5 wt. % versus 3.0 wt % for A-240 pitch. However, due to the decreasing, or inavailability of “sweet” crude oils, there is now difficulty in producing the A-225 pitch having the required low sulfur content.

### SUMMARY OF THE INVENTION

The present invention involves the discovery that deep desulfurization through severe hydrotreating of a supply of petroleum fractions derived from sour crude oil having a high sulfur content results in a production of a petroleum feedstock having a desirably low sulfur content. Not only is the sulfur level of the petroleum feedstock reduced by a severe hydrotreatment of a crude oil or fraction thereof, but also the petroleum pitch retains other desirable characteristics including coking value and a desired minimum density.

According to the present invention, the petroleum fractions derived from sour crude oil is severely hydrotreated. The process of the present invention eliminates the need for further hydrotreatment of the residue feedstock. The process also eliminates the need for delayed coking where the petroleum residue is typically heated and subjected to a destruction thermal cracking to produce lower-boiling petroleum distillate products and a solid carbonaceous residue known as coke.

The hydrotreatment involves treating the crude oil fractions with the hydrogen at a partial pressure typically ranging from 800 to 1,500 psi in the presence of at least one suitable hydrotreating catalyst at a temperature of about 500° F. Hydrotreating catalysts are produced commercially and contain one or more of the elements of cobalt, nickel, tungsten, platinum and/or molybdenum on a porous support material such as alumina.

The hydrotreating process produces a petroleum feedstock which can then be subjected to further processing to produce valuable end products having reduced sulfur and low PAH content of about 13,000 mg/kg.

According to one embodiment of the present invention, hydrotreatment is conducted at high temperatures and high pressures. Typically the temperature in the hydrogenation chamber is in the range of about 300° C. to about 450° C., preferably about 350° C. to about 400° C. and the pressure is in the range of about 1000 to 5000psig, preferably about 1500 to 3500psig and most preferably to about 1,400 to 1,500 psig.

The hydrocarbon Weight Hourly Space Velocity (WHSV) may be in the range of 0.1 to about 5, preferably about 0.122. The preferred hydrogen supply can be in the range of about 100 to 2000 mq/ton of hydrocarbon feedstock and preferably in the range of 200 to about 1000 mg/ton. The sour crude oil fraction is treated with hydrogen for sufficient time in order to produce a petroleum feedstock having less than about 1.0 wt. % (10,000 ppm) sulfur and about less than 15,000 mg/kg of PAH.

The treatment chambers can comprise any known chambers suitable for use in the industry. Typically fixed bed reactors are used in for severe hydrotreating operations.

### DESCRIPTION OF THE INVENTION

The present invention relates to a method for producing a low sulfur petroleum feedstock. A supply of a relatively high sulfur content crude oil having an initial content of at least about 1% or greater is severely hydrotreated. The severe hydrotreating comprises exposing the crude oil fractions to high pressures ranging from about 800 to 1,500 p.s.i. for a suitable length of time. The severe hydrotreating reduces the sulfur content to a less than 1 wt %.

The low sulfur petroleum feedstock has approximately 80% less PAH's than typical coal tar pitch and about 50% less PAH's than pitch produced from the residue of ethylene cracking of naphtha. The present invention thus meets a growing need for producing an adequate supply of low sulfur petroleum feedstocks due to the decreasing worldwide availability of coal tar in the United States.

The catalyst compositions for hydrotreating are well known to those skilled in the art and are commercially available. Useful catalysts include cobalt-molybdenum, nickel tungsten, and nickel-molybdenum supported catalysts. Other suitable hydrogen catalysts comprise of platinum alloys. It is an advantage that the catalyst selected be capable of catalyzing the hydrogenation of the compounds without substantially altering the structure or cracking the compounds. Examples of commercially available catalysts include those offered by Topsoe, Shell Criterion, Akzo Nobel, and Grace Davison.

In certain aspects of the present invention, the deep desulfurization can further comprise the use of a new generation of catalysts which are more stable than the other catalysts. Examples of these types of catalysts are tri-metal, such as hydrotreating catalysts that contain cobalt, nickel and molybdenum. Further, the severe hydrotreating allows for more a efficient “change out” of catalysts, thereby making the process more efficient than currently used methods.

The present invention further relates to a unique low sulfur content pitch produced by the above method. The low sulfur, pitch does not depend on a specific initial feedstock or crude oil.

According to another aspect of the present invention, the low sulfur pitch can be produced from relatively high sulfur content crude oils and/or feedstocks, VGO's (volatile gas oils) and slurry oils.

According to the present invention, low sulfur, low PAH pitches having, by weight percent, less than about 0.6 wt. % and, in certain embodiments, less than about 0.3 wt. % are produced. Further, the low sulfur/low PAH pitch of the present invention can be produced with a consistent quality using many different sources of sour crude oils. The present invention thus allows for more efficient use of various types of sour crude oil.

The low sulfur, low PAH petroleum pitch of the present invention is especially useful in producing aluminum anode binders. It is especially important to have low sulfur anodes since presence of sulfur causes corrosion and also severe environmental concerns during the manufacturing of the aluminum.

Further, the present invention has the required high density which meets other industry needs. The low sulfur, law PAH petroleum pitch produced from the low sulfur, low PAH petroleum feedstock which has been severely treated has a density of at least about 1.20 g/cc.

Both the low sulfur, low PAH feedstock and the low sulfur, low PAH pitch product produced from the process of the present invention have a significantly lower concentration of regulated polynuclear aromatic hydrocarbons as compared to feedstock and pitch product derived from ethylene cracker operations. The total regulated polynuclear aromatic hydrocarbon content of pitch products discussed herein has been found to be as follows in Table I below.

TABLE I
Total Regulated Polynuclear Aromatic Hydrocarbon Content of
Various Pitch Materials

| | Total Regulated |
|---|---|
| | Polynuclear Aromatic |
| Type of Pitch | Hydrocarbons (mg/Kg) |
| Coal Tar Pitch | 67,400 |
| Pitch Derived from the Residue from Ethylene | 35,900 |
| Cracking of Naphtha | |
| Ethylene Cracker Bottom (naphtha derived) | 13,000 |
| Marathon Ashland Petroleum A-240 Pitch | 8,000 |
| Marathon Ashland Petroleum A-225 Pitch | 10,200 |
| Pitch Feedstock Produced By Method of | 12,600 |
| Invention | |

Use of a petroleum feedstock that received severe hydrotreating during the preparation step is successful in producing a petroleum pitch with low sulfur, while retaining other “normal” pitch properties. Properties of the final product are shown in Table II. The sulfur content of this feedstock are 0.5 wt % and lower.

TABLE II
Properties of Low Sulfur Pitch Produced from Feedstock Which
Received Severe Hydrotreating During Preparation

| | Acceptable | | |
|---|---|---|---|
| Analysis | Ranges | Ex. 1 | Ex. 2 |
| Softening Point, Mettler, ° C. | 118 maximum | 121.0 | 121.4 |
| Coking Value, Modified | 49 minimum | 51.2 | 51.6 |
| Conradson Carbon, wt % | | | |
| Sulfur, wt % | 1.50 maximum | 0.47 | 0.47 |
| Ash, wt % | 0.2 maximum | 0.04 | 0.05 |
| Quinoline Insolubles, wt % | 0.5 maximum | <0.1 | <0.1 |
| Toluene Insolubles, wt % | 2.0 maximum | 5.1 | 3.8 |
| Flash Point, ° C. | 250 minimum | 274 | 278 |
| Density, g/cc | 1.20 minimum | 1.23 | 1.22 |

Specific compositions, methods, or embodiments discussed are intended to be only illustrative of the invention disclosed by this specification. Variations on these compositions, methods, or embodiments are readily apparent to a person of skill in the art based upon the teachings of this specification and are therefore intended to be included as part of the inventions disclosed herein.

Reference to documents made in the specification is intended to result in such patents or literature being expressly incorporated herein by reference including any patents or other literature references cited within such documents.

We claim:

1. A method for producing a low sulfur and low polycyclic aromatic hydrocarbon (PAH) petroleum feedstock comprising:
hydrotreating a supply of relatively high sulfur content fractions derived from crude oil having an initial sulfur content of about 1 wt % or greater,
whereby the resulting, low PAH, low sulfur petroleum feedstock has a sulfur content of about 1 wt %.

2. The method of claim 1, in which the sulfur content of the petroleum pitch feedstock is about 0.8 wt % or less.

3. The method of claim 1 in which the petroleum feedstock produced comprises at least one of a vacuum or atmospheric gas oils.

4. The method of claim 1 in which the petroleum feedstock produced comprises slurry or decant oils.

5. The method of claim 1 in which the petroleum feedstock produced comprises extracts from at least one solvent de-asphalting or lube oil production process.

6. The method of claim 1 in which hydrotreating comprises exposing the fractions derived from crude oil to high pressures ranging from about 800 to 1,500 psi for a suitable length of time.

7. The method of claim 6 in which the crude oil fractions are exposed to a catalyst comprising of various metals such as cobalt, nickel and molybdenum on various supports.

8. The method of claim 1 in which the low sulfur/low PAH petroleum pitch product has the following properties:

| | |
|---|---|
| Softening Point, Mettler, ° C. | 70 minimum |
| | 130 maximum |
| Coking Value, Modified about | 38 minimum |
| Conradson Carbon, wt % | |
| Sulfur, wt % | 1.00 maximum |
| Ash, wt % | 0.2 maximum |
| Quinoline Insolubles, wt % | 0.5 maximum |
| Toluene Insolubles, wt % | 2.0 minimum |
| | 10.0 maximum |
| Flash Point, ° C. | 250 minimum |
| Density, g/cc about | 1.20 minimum |

9. The method of claim 8, in which the petroleum feedstock has a sulfur content of about 0.5. wt % or less.

10. A method for producing anode binder quality petroleum feedstock comprising the method of claim 1.

11. A low sulfur petroleum feedstock produced by severely hydrotreating a supply of relatively high sulfur content fractions derived from crude oil having an initial sulfur content of about 2 wt % or greater,
whereby the low sulfur petroleum feedstock has a sulfur content of about 1 wt % or lower.

12. The feedstock of claim 11, in which the sulfur content of the petroleum pitch feedstock is about 0.8 wt % (8000 ppm) or less.

13. The feedstock of claim 11, in which the petroleum feedstock comprises at least one of vacuum or atmospheric gas oils.

14. The feedstock of claim 11, in which the petroleum feedstock comprises slurry or decant oils.

15. The method of claim 11, in which the petroleum feedstock comprises extracts from at least one solvent de-asphalting or lube oil production processes.

16. The method of claim 11, in which the severe hydrotreating comprises exposing the crude oil to pressures ranging from about 1,100 psi for a suitable length of time.

17. The method of claim 16, in which the crude oil is exposed to catalyst containing at least one of cobalt, molybdenum, nickel, and/or tungsten supported catalysts.

16. The feedstock of claim 11, wherein the low sulfur petroleum product has the following properties:

| | |
|---|---|
| Softening Point, Mettler, ° C. | 70 minimum |
| | 130 maximum |
| Coking Value, Modified about | 38 minimum |
| Conradson Carbon, wt % | |
| Sulfur, wt % | 1.00 maximum |
| Ash, wt % | 0.2 maximum |
| Quinoline Insolubles, wt % | 0.5 maximum |
| Toluene Insolubles, wt % | 2.0 minimum |
| | 10.0 maximum |
| Flash Point, ° C. | 250 minimum |
| Density, g/cc about | 1.20 minimum |

17. A low sulfur pitch product produced using method of claim 1 having a PAH concentration less than about 13,000 mg/kg.

18. A pitch material as described and claimed in claim 1, wherein the pitch material is adaptable for use as an aluminum binder.

19. A pitch material as described and claimed in claim 1, wherein the pitch material is adaptable for use as carbon-carbon composite ingredient.

20. A pitch material as described and claimed in claim 1, wherein the pitch material is adaptable for use as carbon fiber ingredient.

21. A pitch product produced using method of claim 9.

22. A pitch material as described and claimed in claim 9, wherein the pitch material is adaptable for use as an aluminum binder.

23. A pitch material as described and claimed in claim 9, wherein the pitch material is adaptable for use as carbon-carbon composite ingredient.

24. A pitch material as described and claimed in claim 9, wherein the pitch material is adaptable for use as carbon fiber ingredient.
